(19) United States
(12) Patent Application Publication
(10) Pub. No.: US 2026/0246306 A1
(43) Pub. Date: Aug. 20, 2026

(54) APPARATUS FOR TRANSMITTING POWER WIRELESSLY

(71) Applicant: Hitachi-LG Data Storage Korea, Inc., Seoul (KR)

(72) Inventors: Su Cheol KIM, Seoul (KR); Sung Hwan DO, Seoul (KR); Chae Min JU, Seoul (KR)

(73) Assignee: Hitachi-LG Data Storage Korea, Inc., Seoul (KR)

(21) Appl. No.: 18/832,746

(22) PCT Filed: Mar. 14, 2024
(86) PCT No.: PCT/KR2024/003265

§ 371 Date: Jul. 24, 2024

(30) Foreign Application Priority Data
Mar. 14, 2023 (KR) 10-2023-0033296
Mar. 14, 2023 (KR) 10-2023-0033297
Jan. 31, 2024 (KR) 10-2024-0014839
Jan. 31, 2024 (KR) 10-2024-0014840
Feb. 8, 2024 (KR) 10-2024-0019825

(51) Int. Cl. H02J 50/40; H02J 50/12; H02J 50/70; H02J 50/90; H02M 7/5387

(52) U.S. Cl. CPC H02J 50/402; H02J 50/12; H02J 50/70; H02J 50/90; H02M 7/5387

(57) ABSTRACT

The disclosure relates to an apparatus for transmitting power wirelessly. The apparatus for transmitting power wirelessly according to an embodiment of the disclosure may comprise: a first induction coil; an inverter configured to convert a direct current into an alternating current and provide the alternating current to the first induction coil; and a magnetic assembly including a plurality of magnetic elements disposed in a Halbach array outside the first induction coil.

### TECHNICAL FIELD

This disclosure relates to an apparatus for transmitting power wirelessly.

### BACKGROUND ART

With the development of communication and information processing technology, use of smart terminals such as a smart phone and the like has gradually increased and at present, a charging scheme generally applied to the smart terminals is a scheme that directly connects an adapter connected to a power supply to the smart terminal to charge the smart phone by receiving external power or connects the adapter to the smart terminal through a USB terminal of a host to charge the smart terminal by receiving USB power.

In recent years, in order to reduce inconvenience that the smart terminal needs to be directly connected to the adapter or the host through a connection line, a wireless charging scheme that wirelessly charges a battery by using magnetic coupling without an electrical contact has been gradually applied to the smart terminal.

There are several methods for wirelessly supplying or receiving electrical energy, representatively, an inductive coupling method based on electromagnetic induction and a resonance coupling method (that is electromagnetic resonance coupling method) based on an electromagnetic resonance phenomenon using a wireless power signal of a specific frequency.

In both methods, it is possible to secure stability of power transmission and increase transmission efficiency by exchanging data through the communication channel formed between a wireless charging apparatus and an electronic device such as a smart terminal. The inductive coupling method has a problem in that the transmission efficiency is lowered by the movement of the power receiving apparatus while wirelessly receiving power, and the resonant coupling method has a problem in that power transmission is interrupted due to noise occurring in the communication channel.

Meanwhile, the standards for basic power profile (BPP), enhanced power profile (EPP), and magnetic power profile (MPP) have been proposed in order to increase the transmission efficiency of the inductive coupling method. Among these, in the MPP, DC magnets are used to automatically align wireless power transmission and reception coils.

However, several important problems arise in actual use despite the BPP, EPP, and MPP standards proposed to increase the transmission efficiency of the inductive coupling method. For example, the automatic alignment function using the DC magnets proposed in the MPP standard is efficient theoretically, but in practice, a case is often mounted on an electronic device, which increases a distance between a primary coil and a secondary coil and degrades alignment efficiency. This increase in distance weakens an interaction of the DC magnets and is a main cause of difficulty in correct alignment.

Further, an existing single coil structure proposed in the MPP standard is not suitable for a multi-coil system that charges electronic devices having various sizes and shapes. A current structure is a single structure in which a primary coil and a secondary coil are coupled one to one, and therefore, the development of a new multi-coil structure is necessary to efficiently charge the electronic devices having various sizes and shapes. In addition, a new design strategy responding to change in performance due to the magnets around a central coil is required when the multi-coil structure is applied.

### DISCLOSURE

### Technical Problem

The present disclosure takes this situation into consideration, and an object of the present disclosure is to provide a magnet structure that strengthens a magnetic force between a transmitting unit and a receiving unit.

Further, an object of the present disclosure is to provide a wireless power transmitting apparatus that can support all of BPP, EPP, and MPP.

Further, an object of the present specification is to provide a core structure that can maximize the magnetic coupling of an MPP coil.

Further, an object of the present disclosure is to provide a magnet structure that minimizes a transfer loss that occurs during power is transmitted through a side coil of a transmitting unit, when magnets are used to align the center transmitting coil of the transmitting unit using a plurality of transmitting coils and the receiving coil of a receiving unit.

The problems to be solved in the present disclosure are not limited to the problems mentioned above, and other problems not mentioned can be clearly understood by those skilled in the art from the description below.

### Technical Solution

The apparatus for transmitting power wirelessly according to an embodiment of this disclosure may comprise: a first induction coil, a second induction coil and a third induction coil having axes in the same direction as that of an axis of the first induction coil and disposed on one side and the other side with respect to the axis of the first induction coil, and a magnetic assembly including a plurality of magnetic elements disposed along an outer circumference of the first induction coil outside the first induction coil, and two adjacent magnetic elements among the plurality of magnetic elements may be disposed to be spaced apart from each other to form a gap in a second central portion of the second induction coil or a third central portion of the third induction coil.

### Advantageous Effects

As described above, according to the present embodiment, it is possible to improve alignment performance between a transmitting unit and a receiving unit by proposing a new DC magnet structure.

It is possible to maintain magnetic coupling while using fewer magnets or magnets with a lower magnetic force, resulting in reduction in cost and weight.

It is possible to improve an output side voltage level by proposing circuit structure and sequence of a transmission unit that can support all the BPP, EPP, and MPP standards.

It is possible to extend a charging area compared to an existing 1:1 coil structure and satisfy all the BPP, EPP, and MPP standards by using a 3-coil structure in which DC magnets are utilized.

It is possible to further improve magnetic coupling compared to an existing flat core by classifying coil structures into two types depending on a position of a central coil (MPP coil) and proposing a core structure optimized for each type.

It is possible to support the MPP standard for a central coil in a three-coil structure with a wide charging area and to prevent efficiency from being degraded at the time of BPP and EPP driving with a side coil.

### DESCRIPTION OF DRAWINGS

FIG. 1 conceptually illustrates that power is wirelessly transmitted from a wireless power transmitting apparatus to an electronic device.

FIG. 2 conceptually illustrates a circuit configuration of a power conversion unit of a transmitting module for wirelessly transmitting power in an electromagnetic induction scheme.

FIG. 3 illustrates a configuration for a wireless power transmitting module and a wireless power receiving module to send and receive power and messages.

FIG. 4 is a block diagram of a loop for controlling power transmission between a wireless power transmitting module and a wireless power receiving module.

FIG. 5 schematically illustrates an embodiment of a first induction coil and a magnetic assembly.

FIGS. 6A and 6B conceptually illustrate the magnetic coupling between a power receiving apparatus and a power transmitting apparatus according to various embodiments.

FIGS. 7A and 7B schematically illustrate the disposition of induction coils according to various embodiments.

FIG. 8 illustrates a circuit configuration of FIG. 2 in a more specific embodiment.

FIGS. 9A to 9C illustrate the graphs showing a coupling coefficient between the power receiving apparatus and the power transmitting apparatus in the disposition of the induction coils of the embodiment illustrated in FIG. 7A.

FIGS. 10A to 10C illustrate the graphs showing a coupling coefficient between the power receiving apparatus and the power transmitting apparatus in the disposition of the induction coils of the embodiment illustrated in FIG. 7B.

FIG. 11 is a diagram illustrating the disposition of the core made of ferrite material in accordance to an embodiment.

FIG. 12 is a diagram illustrating the disposition of the core made of ferrite material in accordance to another embodiment.

FIG. 13 is an exploded perspective view schematically illustrating a coil assembly according to an embodiment.

FIG. 14 is a diagram schematically illustrating numbered magnetic elements or magnetic units and induction coils.

FIG. 15 illustrates a graph showing a transfer loss amount according to a combination of the magnetic elements or the magnetic units numbered according to FIG. 14, and shows a power loss amount measured or calculated while removing some of the magnetic elements constituting the magnetic assembly.

### MODE FOR INVENTION

Hereinafter, an embodiment of an apparatus and method for transmitting power wirelessly will be described in detail with reference to the accompanying drawings.

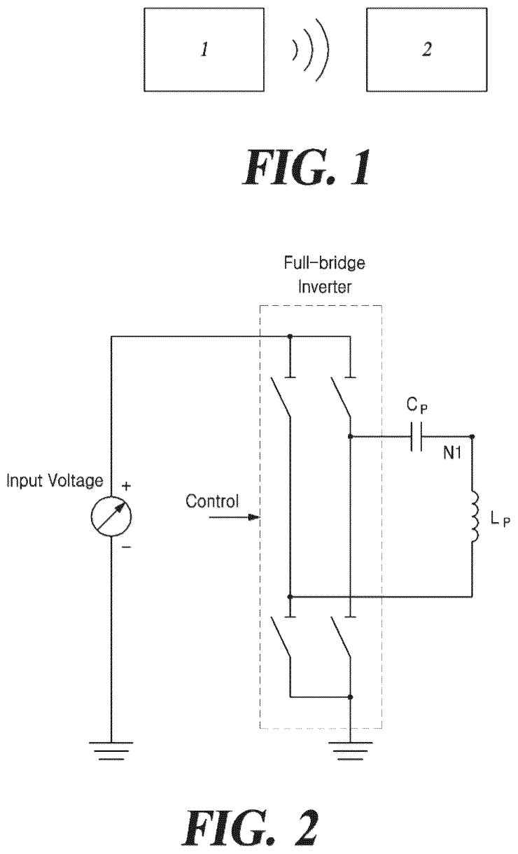

FIG. 1 conceptually illustrates that power is wirelessly transmitted from a wireless power transmitting apparatus to an electronic device.

The wireless power transmitting apparatus 1 may be a power transferring apparatus wirelessly transferring power required by a wireless power receiving apparatus or an electronic device 2, or a wireless charging apparatus for charging a battery by wirelessly transferring power. Or the wireless power transmitting apparatus 1 may be implemented by one of various types of apparatuses transferring power to the electronic device 2 requiring power with non-contact.

The electronic device 2 may be operable by wirelessly receiving power from the wireless power transmitting apparatus 1 and charge a battery by using wirelessly received power. The electronic device that wirelessly receives power may include portable electronic devices, for example, a smart phone, a tablet computer, a multimedia terminal, an input/output device such as a keyboard, a mouse, a video or audio auxiliary device, a secondary battery, and the like.

Power may be wirelessly transmitted by an inductive coupling scheme based on an electromagnetic induction phenomenon by a wireless power signal generated by the wireless power transmitting apparatus 1. That is, resonance is generated in the electronic device 2 by the wireless power signal transmitted by the wireless power transmitting apparatus 1 and power is transferred from the wireless power transmitting apparatus 1 to the electronic device 2 without contact by the resonance. A magnetic field is changed by an AC current in a primary coil and current is induced to a secondary coil by the electromagnetic induction phenomenon to transfer power.

When the intensity of the current that flows on a primary coil of the wireless power transmitting apparatus 1 is changed, the magnetic field passing through the primary coil (or a transmitting Tx coil or a first coil) is changed by the current and the changed magnetic field generates induced electromotive force at a secondary coil (or a receiving Rx coil or a second coil) in the electronic device 2.

When the wireless power transmitting apparatus 1 and the electronic device 2 are disposed such that the transmitting coil at the wireless power transmitting apparatus 1 and the receiving coil at the electronic device 2 come close to each other and the wireless power transmitting apparatus 1 controls the current of the transmitting coil to be changed, the electronic device 2 may supply power to a load such as a battery by using the electromotive force induced to the receiving coil.

Efficiency of the wireless power transmission based on the inductive coupling scheme is influenced by a layout and a distance between the wireless power transmitting apparatus 1 and the electronic device 2. The wireless power transmitting apparatus 1 is configured to include a flat interface surface and a transmitting coil is mounted on the bottom of the interface surface and one or more electronic devices may be laid on the top of the interface surface. By making the gap between the transmitting coil mounted on the bottom of the interface surface and the receiving coil positioned on the top of the interface surface sufficiently small, the efficiency of the wireless power transmission by the inductive coupling method can be increased.

A mark indicating a location where the electronic device is to be laid may be displayed on the top of the interface surface of the wireless power transmitting apparatus. The mark may indicate indicate the position of the electronic device which makes the arrangement between the primary coil mounted on the bottom of the interface surface and the secondary coil suitable. A protruded structure for guiding the location of the electronic device may be formed on the top of the interface surface. And a magnetic body may be formed on the bottom of the interface surface so that the primary coil and the secondary coil can be guided by an attractive force with a magnetic body of the other pole provided inside the electronic device.

FIG. 2 conceptually illustrates a circuit configuration of a power conversion unit of a transmitting module for wirelessly transmitting power in an electromagnetic induction scheme.

The wireless power transmitting module may include a power conversion unit generally including a power source, an inverter, and a resonance circuit. The power source may be a voltage source or a current source and the power conversion unit converts the power supplied from the power source into a wireless power signal and transfers the converted wireless power signal to a power receiving module. The wireless power signal is formed in the form of the magnetic field or an electronic magnetic field having a resonance characteristic. And, the resonance circuit includes a coil generating the wireless power signal.

The inverter converts a DC input into an AC waveform having a desired voltage and a desired frequency through switching elements and a control circuit. And, in FIG. 2 a full-bridge inverter is illustrated and other types of inverters including a half-bridge inverter, and the like are also available.

The resonance circuit includes a primary coil Lp and a capacitor Cp to transmit power based on a magnetic induction scheme. The coil and the capacitor determine a basic resonance frequency of power transmission. The primary coil forms the magnetic field corresponding to the wireless power signal with a change of current and may be implemented in a flat form or a solenoid form.

The AC current converted by the inverter drives the resonance circuit, and as a result, the magnetic field is formed in the primary coil. By controlling the on/off timings of included switches, the inverter generates AC having a frequency close to the resonance frequency of the resonance circuit to increase transmission efficiency of the transmitting module. The transmission efficiency of the transmitting module may be changed by controlling the inverter.

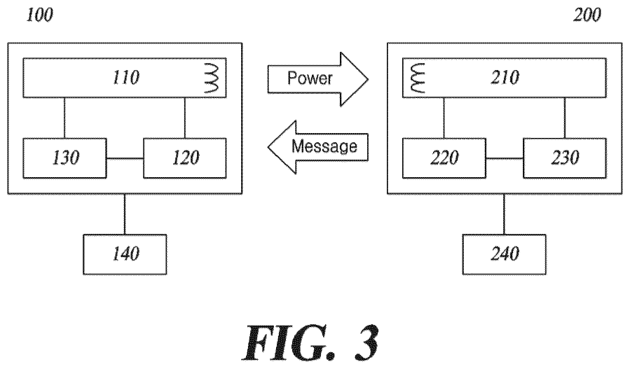

FIG. 3 illustrates a configuration for a wireless power transmitting module and a wireless power receiving module to send and receive power and messages.

Since the power conversion unit just transmits power unilaterally regardless of a receiving state of the receiving module, a configuration for receiving feedback associated with the receiving state from the receiving module is required in the wireless power transmission module in order to transmit power in accordance with the state of the receiving module.

The wireless power transmitting module 100 may include a power conversion unit 110, a communication unit 120, a control unit 130, and a power supply unit 140. And, the wireless power receiving module 200 may include a power receiving unit 210, a communication unit 220, and a control unit 230 and may further include a load 240 (or a power supply unit) to which received power is to be supplied. The load 240 may include a charging unit for charging an internal battery with power supplied from the power receiving unit 210.

The power conversion unit 110 includes the inverter and the resonance circuit of FIG. 2 and may further include a circuit to control characteristics including a frequency, voltage, current, and the like used to form the wireless power signal.

The communication unit 120, connected to the power conversion unit 110, may demodulate the wireless power signal modulated by the receiving module 200 wirelessly receiving power from the transmitting module 100 in the magnetic induction scheme, thereby detecting a power control message.

The control unit 130 determines one or more characteristics among an operating frequency, voltage, and current of the power conversion unit 110 based on the message detected by the communication unit 120 and controls the power conversion unit 110 to generate the wireless power signal suitable for the message. The communication unit 120 and the control unit 130 may be configured as one module.

The power receiving unit 210 may include a matching circuit, including the secondary coil and a capacitor, which generates the inductive electromotive force according to the change of the magnetic field generated from the primary coil of the power conversion unit 110, and may further include a rectification circuit that rectifies the AC current that flows on the secondary coil to output DC current.

The communication unit 220, connected to the power receiving unit 210, may change the wireless power signal between the transmitting module and the receiving module by adjusting the load of the power receiving unit in accordance with a method of adjusting a resistive load at DC and/or a capacitive load at AC to transmit the power control message to the transmitting module.

The control unit 230 of the receiving module controls individual components included in the receiving module. The control unit 230 may measure an output of the power receiving unit 210 in a current or voltage form and control the communication unit 220 based on the measured output to transfer the power control message to the wireless power transmitting module 100. The message may direct the wireless power transmitting module 100 to start or terminate the transmission of the wireless power signal and to control characteristics of the wireless power signal.

The wireless power signal formed by the power conversion unit 110 is received by the power receiving unit 210, and the control unit 230 of the receiving module controls the communication unit 220 to modulate the wireless power signal. The control unit 230 may perform a modulation process to change the amount of power received from the wireless power signal by changing the reactance of the communication unit 220. When the amount of power received from the wireless power signal is changed, a current and/or voltage of the power conversion unit 110 forming the wireless power signal is also changed and the communication unit 120 of the wireless power transmitting module 100 may sense the change in the current and/or voltage of the power conversion unit 110 and perform a demodulation process.

The control unit 230 generates a packet including a message to be transferred to the wireless power transmitting module 100 and modulates the wireless power signal to include the generated packet. The control unit 130 may acquire the power control message by decoding the packet extracted through the communication unit 120. The control unit 230 may transmit a message for requesting a change of the characteristic of the wireless power signal based on the amount of power received through the power receiving unit 210 in order to control to-be-received power.

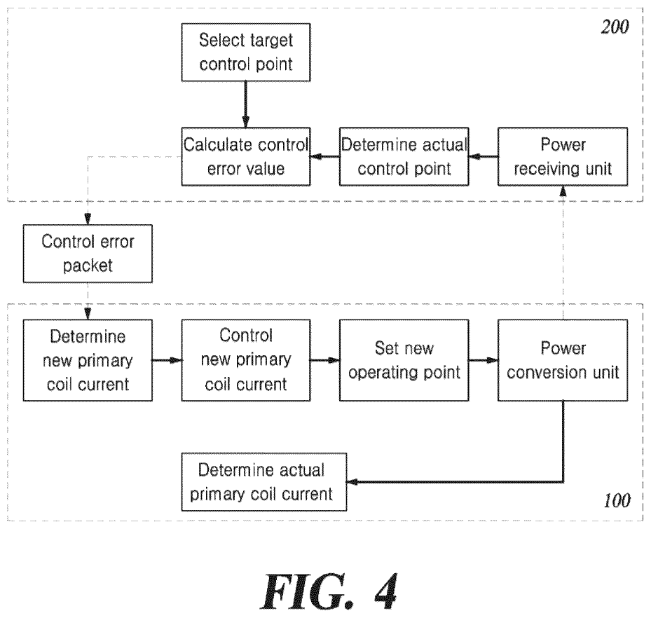

FIG. 4 is a block diagram of a loop for controlling power transmission between a wireless power transmitting module and a wireless power receiving module.

Current is induced in the power receiving unit 210 of the receiving module 200 according to the change of the magnetic field generated by the power conversion unit 110 of the transmitting module 100 and power is transmitted. The control unit 230 of the receiving module selects a desired control point, that is, a desired output current and/or voltage and determines an actual control point of the power received through the power receiving unit 210.

The control unit 230 calculates a control error value by using the desired control point and the actual control point while the power is transmitted and may take the difference between, for example, two output voltages or two output currents as the control error value. When less power is required to reach the desired control point, the control error value may be determined to be, for example, a minus value, and when more power is required to reach the desired control point, the control error value may be determined to be a plus value. The control unit 230 may generate a packet including the calculated control error value calculated by changing the reactance of the power receiving unit 210 with time through the communication unit 220 to transmit the packet to the transmitting module 100.

The communication unit 120 of the transmitting module detects a message by demodulating the packet included in the wireless power signal modulated by the receiving module 200 and may demodulate a control error packet including the control error value.

The control unit 130 of the transmitting module may acquire the control error value by decoding the control error packet extracted through the communication unit 120 and determine a new current value for transmitting power desired by the receiving module by using an actual current value which actually flows on the power conversion unit 110 and the control error value. When the process of receiving the control error packet from the receiving module is

stabilized, the control unit 130 of the transmitting module controls the power conversion unit 110 so that an operating point reaches a new operating point so an actual current value which flows on the primary coil becomes a new current value and a magnitude, a frequency, a duty ratio, or the like of an AC voltage applied to the primary coil becomes a new value. And, the control unit 130 controls the new operating point to be continuously maintained so as for the receiving module to additionally communicate control information or state information.

Interactions between the wireless power transmitting module 100 and the wireless power receiving module 200 may comprise four steps of selection, ping, identification and configuration, and power transfer. The selection step is a step for the transmitting module to discover an object laid on the surface of an interface. The ping step is a step for verifying whether the object includes a receiving module. The identification and configuration step is a preparation step for sending power to the receiving module during which appropriate information is received from the receiving module and a power transfer contract with the receiving module is made based on the received information. The power transfer step is a step of actually transmitting power to the receiving module wirelessly through the interaction between the transmitting module and the receiving module.

In the ping step, the receiving module 200 transmits a signal strength packet SSP indicating a magnetic flux coupling degree between a primary coil and a secondary coil through the modulation of a resonance waveform. The signal strength packet SSP is a message generated by the receiving module based on a rectified voltage. The transmitting module 100 may receive the message from the receiving module 200 and use the message to select an initial driving frequency for power transmission.

In the identification and configuration step, the receiving module 200 transmits to the transmitting module 100 an identification packet including a version, a manufacturer code, apparatus identification information, and the like of the receiving module 200, a configuration packet including information including maximum power, a power transmitting method, and the like of the receiving module 200, and the like.

In the power transmitting step, the receiving module 200 transmits to the transmitting module 100 a control error packet CEP indicating a difference between an operating point where the receiving module 200 receives a power signal and the operating point determined in the power transfer contract, a received power packet RPP indicating an average of the power which the receiving module 200 receives through the surface of the interface, and the like.

The received power packet RPP is the data about the amount of received power, which is obtained by taking a rectified voltage, a load current, an offset power, etc. of the power receiving unit 210 of the receiving module, and continuously transmitted to the transmitting module 100 while the receiving module 200 receives power. The transmitting module 100 receives the received power packet RPP and uses it as an operation factor for power control.

The communication unit 120 of the transmitting module extracts the packets from change in resonance waveform, and the control unit 130 decodes the extracted packets to acquire the messages and controls the power conversion unit 110 based thereon to wirelessly transmit power while changing power transmission characteristics as the receiving module 200 requests.

Meanwhile, in a scheme that wirelessly transfers power based on inductive coupling, the efficiency is less influenced by frequency characteristics, but influenced by the arrangement and distance between the transmitting module 100 and the receiving module 200.

An area which the wireless power signal can reach may be divided into two. A portion of the interface surface through which a high efficiency magnetic field can pass when the transmitting module 100 wirelessly transmits power to the receiving module 200 may be referred to as an active area. An area where the transmitting module 100 can sense the existence of the receiving module 200 may be referred to as a sensing area.

The control unit 130 of the transmitting module may sense whether the receiving module is disposed in or removed from the active area or the sensing area. The control unit 130 may detect whether the receiving module 200 is disposed in the active area or the sensing area by using the wireless power signal formed in the power conversion unit 110 or using a separately provided sensor.

For example, the control unit 130 may detects whether the receiving module exists by monitoring whether the power characteristics for forming the wireless power signal is changed while the wireless power signal is being affected by the receiving module 200 existing in the sensing area. The control unit 130 may perform a process of identifying the receiving module 200 or determine whether to start wireless power transfer, according to a result of detecting the existence of the receiving module 200.

The power conversion unit 110 of the transmitting module may further include a position determination unit. The position determination unit may move or rotate the primary coil in order to increase the efficiency of the wireless power transfer based on the inductive coupling scheme and in particular, be used when the receiving module 200 does not exist in the active area of the transmitting module 100.

The position determination unit may include a driving unit for moving the primary coil so that a distance between the centers of the primary coil of the transmitting module 100 and the secondary coil of the receiving module 200 is within a predetermined range or so that the centers of the primary coil and the secondary coil overlap with each other. To this end, the transmitting module 100 may further include a sensor or a sensing unit for sensing the position of the receiving module 200. And the control unit 130 of the transmitting module may control the position determination unit based on the positional information of the receiving module 200, which is received from the sensor of the sensing unit.

Alternatively, the control unit 130 of the transmitting module may receive control information regarding the arrangement with or distance from the receiving module 200 through the communication unit 120 and control the position determination unit based on the control information.

Further, the transmitting module 100 may include two or more primary coils to increase transmission efficiency by selectively using some primary coils arranged appropriately with the secondary coil of the receiving module 200 among the two or more primary coils. In this case, the position determination unit may determine which primary coils of the two or more primary coils are used for power transmission.

A single primary coil or a combination of one or more primary coils forming the magnetic field passing through the active area may be designated as a primary cell. The control unit 130 of the transmitting module may sense the position of the receiving module 200, determine the active area based on the determined active area, connect the transmitting module configuring the primary cell corresponding to the active area and control the primary coils of the transmitting module to be inductively coupled to the secondary coil of the receiving module 200.

Meanwhile, since the receiving module 200 is embedded in a smart terminal or an electronic apparatus such as a multimedia reproduction terminal or a smart phone and is laid in a direction or a location which is not constant in a vertical or horizontal direction on the surface of the interface of the transmitting module 100, the transmitting module requires a wide active area.

In case that a plurality of the primary coils are used in order to widen the active area, since a number of drive circuits equal to the number of the primary coils are required and the control over a plurality of primary coils is complicated, the cost of the transmitting module, that is, the wireless charger, is increased during commercialization. Further, in order to expand the active area, even when a scheme of changing the location of the primary coil is applied, since it is necessary to provide a transport mechanism for moving the location of the primary coil, there is a problem that a volume and a weight increase and manufacturing cost increases.

A method that extends the active area even with one primary coil of which the location is fixed is effective. However, when the size of the primary coil is just increased, a magnetic flux density per area decreases and magnetic coupling force between the primary coil and the secondary coil is weakened. As a result, the active area is not so increased as expected and the transmission efficiency is also lowered.

As such, it is important to determine an appropriate shape and an appropriate size of the primary coil in order to extend the active area and improve the transmission efficiency. A multi-coil scheme adopting two or more primary coils may be an effective method that extends the active area of the wireless power transmitting module.

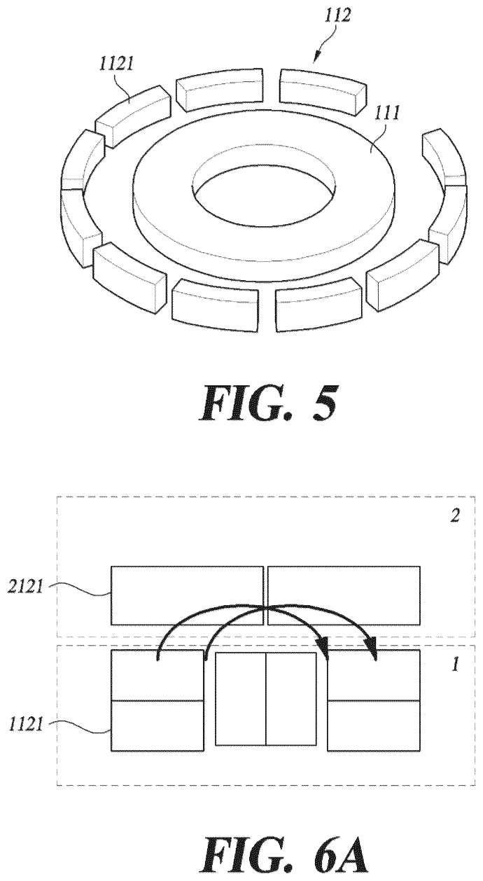

FIG. 5 schematically shows an embodiment of a first induction coil and a magnetic assembly.

The wireless power transmitting apparatus 1 according to the present disclosure may be configured to support Magnetic Power Profile (MPP). The MPP is a profile proposed in the Qi2 standard and includes the information about magnetic alignment between the primary coil and the secondary coil. Specifically, the MPP standard uses magnets between the wireless power transmitting apparatus 1 and the electronic device 2 so that the two objects are aligned in mutually optimal positions, which allows the electronic device 2 to automatically find an optimal position so that power transmission efficiency is maximized when the electronic device 2 is placed on the interface surface.

The wireless power transmitting apparatus 1 includes a first induction coil 111 as a primary coil, and further includes a magnetic assembly 112 including a plurality of magnetic elements disposed on an outer circumference of the first induction coil 111. The plurality of magnetic elements 1121 may satisfy the MPP standard.

Among the plurality of magnetic elements 1121, a predetermined number of magnetic elements 1121 are disposed in a Halbach array to form one magnetic unit 1122, and the magnetic assembly 112 may include a plurality of magnetic units 1122 disposed along the outer circumference of the first induction coil 111.

With respect to the magnetic unit 1122, a predetermined number of magnetic elements 1121 may be arranged along at least a portion of the outer circumference of the first induction coil 111 to form at least a partial section of the outer circumference of the first induction coil 111.

Alternatively, the predetermined number of magnetic elements 1121 constituting the magnetic unit 1122 may be arranged along an axis formed in a radial direction of the first induction coil 111 from the outer side of the first induction coil 111, and a plurality of the arranged magnetic units 1122 may be disposed at predetermined intervals along the outer circumference of the first induction coil 111.

The Halbach array is a special array of permanent magnets and is an array that strengthens a magnetic field on one side and reduces a magnetic field on the other side to substantially zero. This is achieved by disposing the magnets so that poles of the magnets have a phase difference (typically 90 degrees). With this disposition, a magnetic field below the structure of the magnetic assembly 112 (on a non-operating surface) is rearranged above the structure of the magnetic assembly 112 (on an operating surface), so that the magnetic field on the operating surface is enhanced and the magnetic field on the non-operating surface is reduced to substantially zero.

In the case of a power transmitting apparatus of the related art that satisfies the MPP, a magnetic assembly configured such that a direction of a magnetic field is aligned in a specific direction for ease and convenience of coupling between magnetic elements (for example, the magnetic elements are disposed so that the magnetic field is formed along a circumferential direction of a coil) is provided, but such a power transmitting apparatus has a disadvantage that a magnetic force rapidly decreases with an increase in a distance from the receiving apparatus.

The magnetic assembly 112 proposed in the present disclosure provides an effect of improving magnetic performance without reducing power transmission performance between the wireless power transmitting apparatus 1 and the electronic device 2.

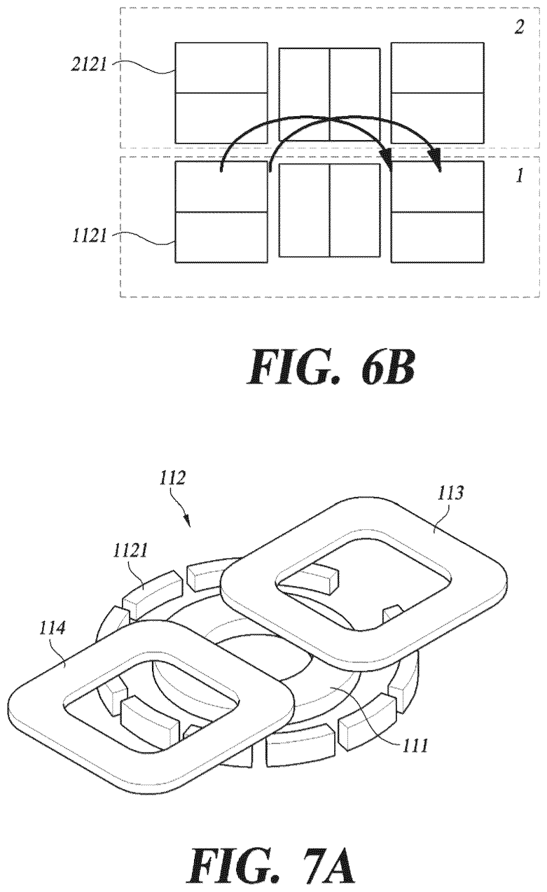

FIGS. 6A and 6B conceptually illustrate the magnetic coupling between a power receiving apparatus and a power transmitting apparatus according to various embodiments. In detail, FIG. 6A conceptually shows the magnetic coupling between the power receiving apparatus employing the magnetic elements in the disposition structure according to the related art and the power transmitting apparatus employing the magnetic elements of the array structure according to the Halbach array, and FIG. 6B conceptually illustrates the magnetic coupling between the power receiving apparatus employing the magnetic elements having the disposition structure according to the Halbach array and the power transmitting apparatus employing the magnetic elements having the disposition structure according to the Halbach array.

It can be seen from FIG. 6A that, even when the magnetic elements 1121 having the disposition structure of the related art are employed in the power receiving apparatus, that is, the electronic device 2, it is possible to form the magnetic attraction between the power receiving apparatus and the power transmitting apparatus employing the magnetic elements 1121 having the disposition structure according to the Halbach array. Further, even when this structure is selected, the effect of improving magnetic performance is provided.

Meanwhile, as illustrated in FIG. 6B, the magnetic attraction between the power receiving apparatus employing the magnetic elements having the disposition structure according to the Halbach array and the power transmitting apparatus employing the magnetic elements having the disposition structure according to the Halbach array is greater than that of the structure of the related art (the power transmitting apparatus and the power receiving apparatus that do not employ the Halbach array).

TABLE 1

| dy | dz | Force_1 | Force_2 | Increase/Decrease Rate |
|---|---|---|---|---|
| 0 | 1.87 | 2.2260 | 2.8400 | 27.6 |
| 0 | 3.87 | 0.7310 | 0.9238 | 26.4 |
| 0 | 5.87 | 0.3494 | 0.3900 | 11.6 |
| 2 | 1.87 | 1.7130 | 2.1620 | 26.2 |
| 2 | 3.87 | 0.6257 | 0.7637 | 22.1 |
| 2 | 5.87 | 0.2970 | 0.3575 | 20.4 |
| 4 | 1.87 | 0.7970 | 0.9990 | 25.3 |
| 4 | 3.87 | 0.3906 | 0.4800 | 22.9 |
| 4 | 5.87 | 0.2029 | 0.2619 | 29.1 |

Table 1 shows the magnitude of magnetic attraction depending on a horizontal distance (dy; degree of disordered array) and a vertical distance (dz; degree of separation) between the magnetic assembly 112 of the wireless power transmitting apparatus 1 and the magnetic assembly (not shown) of the electronic device 2. In Table 1, Force_1 is the magnetic attraction between the power transmitting apparatus and the power receiving apparatus employing the structure of the related art, and Force_2 is the magnetic attraction between the power transmitting apparatus and the power receiving apparatus employing the magnetic elements of the disposition structure according to the Halbach array. Here, units of dy and dz are mm, and a unit of Force is lbf.

It can be seen from Table 1 that, in all cases where the experiment was conducted, the magnetic attraction between the power transmitting apparatus and the power receiving apparatus employing the magnetic elements having the disposition structure according to the Halbach array has increased by an increase/decrease rate of 10 to 30 from the magnetic attraction between the power transmitting apparatus and the power receiving apparatus employing the structure of the related art.

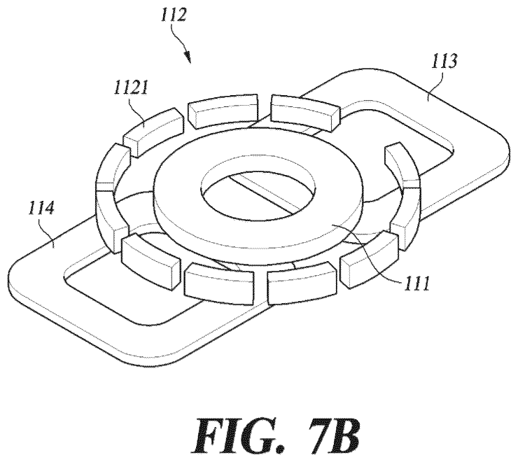

FIGS. 7A and 7B schematically illustrate the disposition of induction coils according to various embodiments.

Referring to FIGS. 7A and 7B, in some embodiments, the wireless power transmitting apparatus 1 may be configured to wirelessly transfer power and may be configured to further include a second induction coil 114 and a third induction coil 113 disposed to have an axis in the same direction as the axis of the first induction coil.

Referring to FIG. 7A, in some embodiments, the second induction coil 114 and the third induction coil 113 may be disposed on the same plane, and the first induction coil 111 may be disposed below the plane (hereinafter referred to as type A).

Referring to FIG. 7B, in some embodiments, the second induction coil 114 and the third induction coil 113 may be disposed on the same plane, and the first induction coil 111 may be disposed above the plane (hereinafter referred to as type B).

Here, the second induction coil 114 and the third induction coil 113 may be disposed to be symmetrical to each other about the axis of the first induction coil. In other words, the second induction coil 114 and the third induction coil 113 may be disposed on one side (for example, the left side in FIG. 7A) and the other side (for example, the right side in FIG. 7A) with respect to the axis of the first induction coil 111.

In such embodiments, the wireless power transmitting apparatus 1 provides the primary coil as a multi-coil structure, and this structure improves user convenience by providing a wider power transmission area.

Further, in such embodiments, the wireless power transmitting apparatus 1 may be configured to further support at least one of the basic power profile (BPP) and the enhanced power profile (EPP). Accordingly, the wireless power transmitting apparatus 1 provides an advantage of being compatible with various types of electronic devices 2 by supporting the power transmission according to the BPP or the EPP even when the electronic device 2 does not support the MPP.

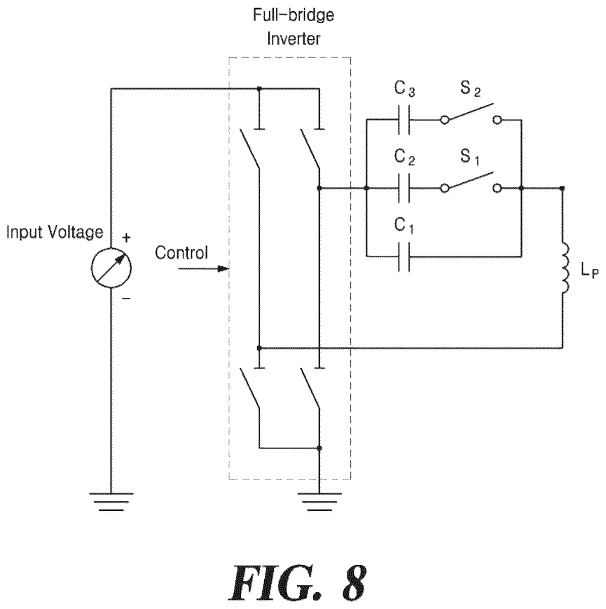

FIG. 8 illustrates a circuit configuration of FIG. 2 in a more specific embodiment.

In an embodiment in which the MPP, EPP, and BPP are all supported, it is necessary to correct a circuit in order to satisfy all operating conditions in the MPP, EPP, and BPP proposed in the Qi standard. Specifically, the capacitance and sequence of the resonance circuit of the wireless power transmitting apparatus 1 presented in the MPP have a voltage gain that is difficult to support the BPP and the EPP. Accordingly, the present disclosure proposes the structure of the resonance circuit that can support all the BPP, EPP, and MPP standards.

In an embodiment in which the operating conditions in both the EPP and the BPP are satisfied, the resonance circuit is configured to have an effective capacitance of 500 nF when an operating frequency of the inverter is 127 kHz.

Meanwhile, in an embodiment in which the operating conditions are satisfied in the MPP, the resonance circuit is configured to have an effective capacitance of 15 to 20 nF when the operating frequency of the inverter is 360 kHz.

The resonance circuit that can support all the BPP, EPP, and MPP standards has a configuration in which a first capacitor C1, a second capacitor C2, and a third capacitor C3 coupled in parallel with each other are included, and switches S1 and S2 are respectively coupled in series to the second capacitor C2 and the third capacitor C3, like the resonance circuit illustrated in FIG. 8. Here, the first capacitor C1 has a capacitance of 15 nF, the second capacitor C2 has a capacitance of 5 nF, and the third capacitor C3 has a capacitance of 480 nF.

In this configuration of the resonant circuit, it is possible to support all of the BPP, the EPP, and the MPP by controlling the resonant circuit so that S1 and S2 are switched according to three driving situations including BPP/EPP, low-coupling MPP, and high-coupling MPP. Specifically, it is possible to acquire an effective capacitance of 500 nF by performing the operation of turning on both the switches S1 and S2 at the operating frequency of the inverter of 127 kHz, thereby satisfying both the operating conditions in the EPP and the BPP. Further, it is possible to acquire an effective capacitance of 20 nF or 15 nF by performing the operation of turning off at least one of the switches S1 and S2 at the operating frequency of the inverter of 360 kHz, thereby satisfying the operating conditions in the MPP (in the provided example, an effective capacitance of 20 nF is acquired when S1 is turned off and S2 is turned on, and 15 nF when both S1 and S2 are turned off).

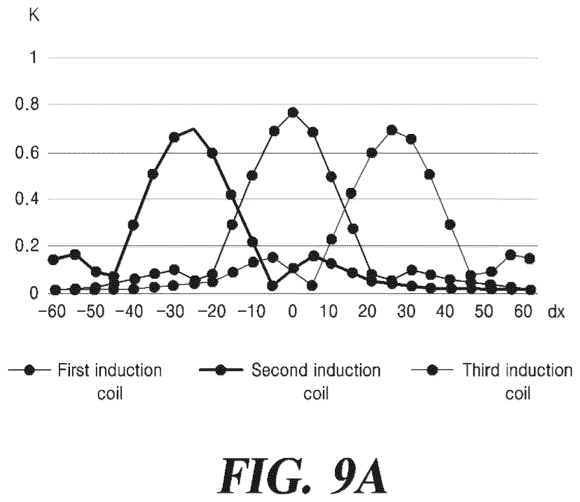

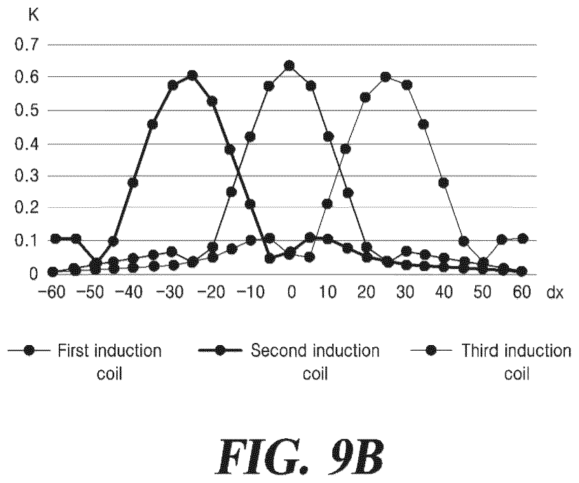

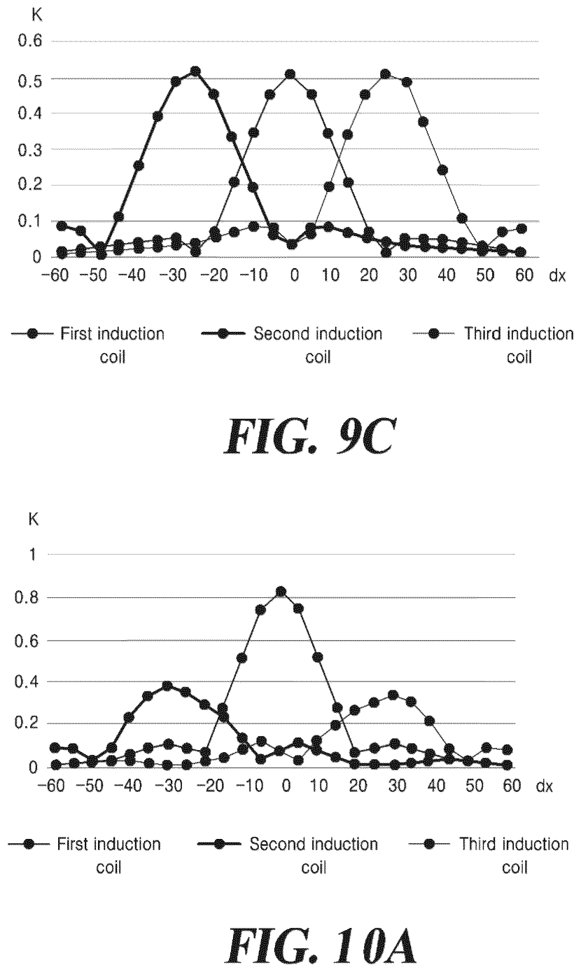

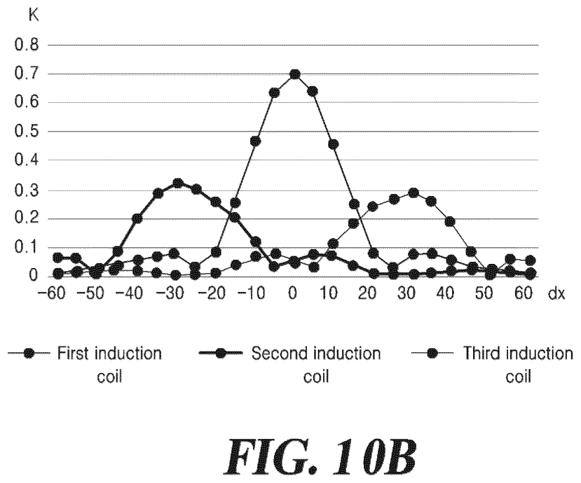

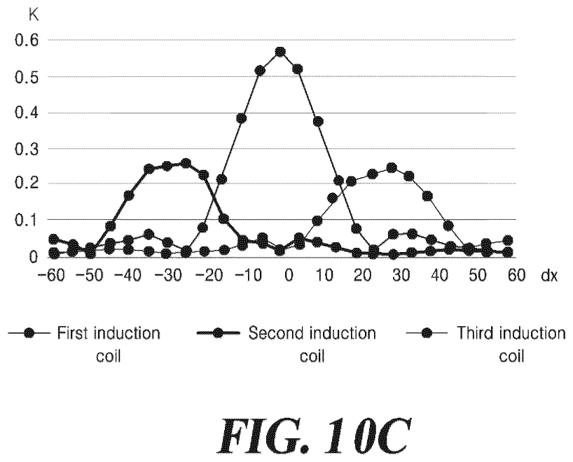

Hereinafter, the coupling coefficient K measured while the power receiving unit 210 of the receiving apparatus is moving horizontally (dx direction) from the right to the left of the power conversion unit 110 in each of embodiments of type A and type B will be described with reference to FIGS. 9A to 10C. Here, the right and left sides of the power conversion unit 110 refer to right and left sides of FIGS. 7A and 7B, and the power receiving unit 210 is moved so that the axis of the power receiving unit 210 is disposed on the same plane as that of axes of the first, second, and third induction coils 111, 113, and 114.

FIGS. 9A to 9C illustrate the graphs showing the coupling coefficient between the power receiving apparatus and the power transmitting apparatus in the disposition of the induction coils of the embodiment illustrated in FIG. 7A. Specifically, the graph in FIG. 9A shows the coupling coefficients when the vertical distance between the power receiving unit 210 and the power conversion unit 110 is 1.87 mm in the embodiment of type A, the graph in

FIG. 9B shows the coupling coefficients when the vertical distance between the power receiving unit 210 and the power conversion unit 110 is 3.87 mm in the embodiment of type A, and the graph in FIG. 9C shows the coupling coefficients when the vertical distance between the power receiving unit 210 and the power conversion unit 110 is 5.87 mm in the embodiment of type A. FIGS. 10A to 10C are the graphs showing a coupling coefficient between the power

receiving apparatus and the power transmitting apparatus in disposition of induction coils of the embodiment illustrated in FIG. 7B. Specifically, the graph in FIG. 10A shows the coupling coefficients when the vertical distance between the power receiving unit 210 and the power conversion unit 110 is 1.87 mm in the embodiment of type B, the graph in FIG. 10B shows the coupling coefficients when the vertical distance between the power receiving unit 210 and the power conversion unit 110 is 3.87 mm in the embodiment of type B, and the graph in FIG. 10C shows the coupling coefficients when the vertical distance between the power receiving unit 210 and the power conversion unit 110 is 5.87 mm in the embodiment of type B.

Referring to FIGS. 9A to 10C, Kmax of the first induction coil 111 in the embodiment of type A is lower than that in the embodiment of type B, but Kmax of the second and third induction coils 113 and 114 in the embodiment of type A are higher than that of the embodiment of type B. Accordingly, in order to smoothly support all BPP, EPP, and MPP, it is desirable to provide the wireless power transmitting apparatus 1 as the embodiment of type A, but the present invention is not limited thereto.

As in the above-described embodiment, there is an advantage that the wireless power transmitting apparatus 1 supporting all of the BPP, the EPP, and the MPP can selectively support the BPP, the EPP, or the MPP by selectively driving the three coils for each position of the electronic device 2 disposed on the interface surface. Further, there is an advantage that the electronic device 2 supporting the MPP can perform charging using the first induction coil 111, and the electronic device 2 supporting the BPP and/or the EPP can perform charging using one of the three coils or two of the three coils at the same time.

Meanwhile, the present disclosure additionally proposes the structure for optimizing transfer coefficients of the first, second, and third induction coils 111, 113, and 114 in the case of each of the embodiment of type A and the embodiment of type B.

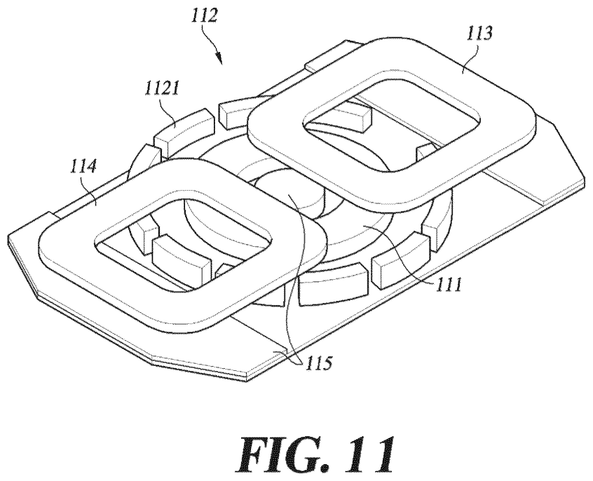

FIG. 11 is a diagram illustrating the disposition of the core made of ferrite material according to an embodiment. Specifically, FIG. 11 illustrates the disposition of the core made of ferrite material provided to optimize the transfer coefficients of the first, second, and third induction coils 111, 113, and 114 in the embodiment of type A.

Referring to FIG. 11, in some of the type A embodiments, the core 115 of ferrite material may be disposed in the central portion of the first induction coil 111 and at least portions below the second and third induction coils 113 and 114. In particular, the core 115 may be disposed at one end portion of the second induction coil 114 and the other end portion of the third induction coil below the second induction coil 114 and the third induction coil 113. Here, one end portion and the other end portion refer to the portions disposed far away from the first induction coil 111.

TABLE 2

| dz | Tx_C | Tx_L | Tx_R | K Increase Rate (%) |
|---|---|---|---|---|
| 0.5 | 0.8564 | 0.1596 | 0.1990 | 1.6 |
| 1.0 | 0.8312 | 0.1455 | 0.1745 | 2.0 |
| 1.5 | 0.8043 | 0.1312 | 0.1546 | 2.4 |
| 2.0 | 0.7759 | 0.1195 | 0.1367 | 2.7 |
| 2.5 | 0.7455 | 0.1080 | 0.1218 | 2.6 |
| 3.0 | 0.7177 | 0.0961 | 0.1083 | 3.0 |
| 3.5 | 0.6884 | 0.0863 | 0.0960 | 3.2 |
| 4.0 | 0.6591 | 0.0765 | 0.0849 | 3.2 |
| 4.5 | 0.6308 | 0.0674 | 0.0746 | 3.4 |
| 5.0 | 0.6021 | 0.0603 | 0.0660 | 3.3 |
| 5.5 | 0.5748 | 0.0524 | 0.0572 | 3.4 |
| 6.0 | 0.5489 | 0.0446 | 0.0501 | 3.5 |

TABLE 3

| dz | Tx_C | Tx_L | Tx_R |
|---|---|---|---|
| 0.5 | 0.0960 | 0.0161 | 0.0221 |
| 1.0 | 0.0837 | 0.0135 | 0.0176 |
| 1.5 | 0.0744 | 0.0114 | 0.0145 |
| 2.0 | 0.0667 | 0.0098 | 0.0120 |
| 2.5 | 0.0600 | 0.0084 | 0.0101 |
| 3.0 | 0.0552 | 0.0072 | 0.0086 |
| 3.5 | 0.0505 | 0.0062 | 0.0073 |
| 4.0 | 0.0467 | 0.0053 | 0.0063 |
| 4.5 | 0.0432 | 0.0046 | 0.0054 |
| 5.0 | 0.0399 | 0.0040 | 0.0046 |
| 5.5 | 0.0372 | 0.0034 | 0.0039 |
| 6.0 | 0.0348 | 0.0028 | 0.0034 |

Tables 2 and 3 show the coupling coefficient and mutual inductance (M) in the embodiment illustrated in FIG. 11. Specifically, the measurement data in Tables 2 and 3 was acquired by measuring K values and M values of the first, second, and third induction coils 111, 113, and 114 while moving the secondary coil which is the receiving coil of the power receiving unit 210 in the direction (dz direction) perpendicular to the plane formed by the coil in a state where the secondary coil is aligned with the first induction coil 111. Here, Tx_C denotes the first induction coil 111, Tx_L denotes the second induction coil 114, Tx_R denotes the third induction coil 113, and respective units of dz and M are mm and uH.

It can be seen from Tables 2 and 3 that the K value was measured to be increased by about 3% in the embodiment in which the core 115 is disposed in the central portion of the first induction coil 111 and at least a portion below the second and third induction coils 113 and 114 compared to the embodiments in which the core 115 is not disposed.

TABLE 4

| dz | Tx_C | Tx_L | Tx_R | K Increase Rate %) |
|---|---|---|---|---|
| 0.5 | 0.1225 | 0.0193 | 0.7497 | 1.9 |
| 1.0 | 0.1128 | 0.2167 | 0.7385 | 2.8 |
| 1.5 | 0.1039 | 0.2380 | 0.7240 | 3.3 |
| 2.0 | 0.0961 | 0.0256 | 0.7078 | 3.7 |
| 2.5 | 0.0874 | 0.0272 | 0.6895 | 4.2 |
| 3.0 | 0.0804 | 0.0285 | 0.6706 | 4.5 |
| 3.5 | 0.0733 | 0.0298 | 0.6517 | 4.7 |
| 4.0 | 0.0664 | 0.0307 | 0.6315 | 5.0 |
| 4.5 | 0.0599 | 0.0315 | 0.6109 | 5.1 |
| 5.0 | 0.0555 | 0.0323 | 0.5900 | 5.2 |
| 5.5 | 0.0488 | 0.0327 | 0.5703 | 5.5 |
| 6.0 | 0.0438 | 0.0331 | 0.5495 | 5.5 |

TABLE 5

| dz | Tx_C | Tx_L | Tx_R |
|---|---|---|---|
| 0.5 | 0.0125 | 0.0016 | 0.0923 |
| 1.0 | 0.0105 | 0.0165 | 0.0812 |
| 1.5 | 0.0090 | 0.0187 | 0.0788 |
| 2.0 | 0.0078 | 0.0018 | 0.0662 |
| 2.5 | 0.0067 | 0.0018 | 0.0604 |
| 3.0 | 0.0060 | 0.0019 | 0.0559 |
| 3.5 | 0.0052 | 0.0019 | 0.0516 |
| 4.0 | 0.0046 | 0.0019 | 0.0481 |
| 4.5 | 0.0040 | 0.0019 | 0.0449 |
| 5.0 | 0.0036 | 0.0019 | 0.0419 |
| 5.5 | 0.0031 | 0.0061 | 0.0395 |
| 6.0 | 0.0027 | 0.0019 | 0.0371 |

Tables 4 and 5 also show the coupling coefficients and mutual inductance in the embodiment illustrated in FIG. 11, like Tables 2 and 3. Specifically, the measurement data in Tables 2 and 3 was acquired by measuring the K values and M values of the first, second, and third induction coils 111, 113, and 114 while moving the secondary coil which is the receiving coil of the power receiving unit 210 in the direction (dz direction) perpendicular to the plane formed by the coil in a state where the secondary coil is aligned with the third induction coil 113. Here, Tx_C denotes the first induction coil 111, Tx_L denotes the second induction coil 114, Tx_R denotes the third induction coil 113, and respective units of dz and M are mm and uH.

It can be seen from Tables 4 and 5 that the K value was measured to be increased by about 4% in the embodiment in which the core 115 is disposed in the central portion of the first induction coil 111 and at least a portion below the second and third induction coils 113 and 114 compared to the embodiments in which the core 115 is not disposed.

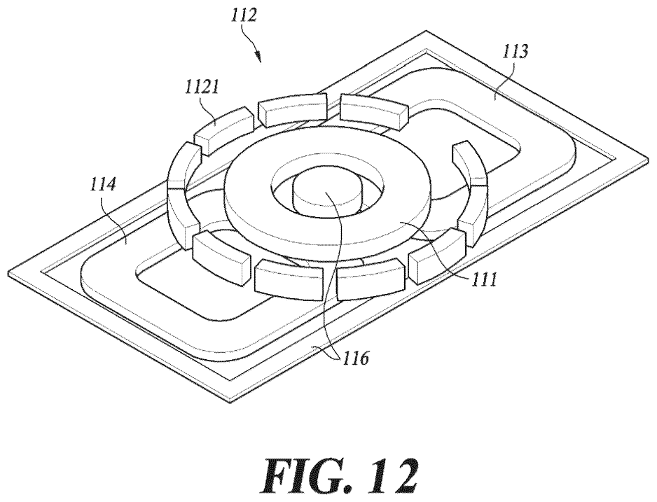

FIG. 12 is a diagram illustrating the disposition of the core made of ferrite material according to another embodiment. Specifically, FIG. 12 illustrates the disposition of the core made of ferrite material provided to optimize the transfer coefficients of the first, second, and third induction coils 111, 113, and 114 in the embodiment of type B.

Referring to FIG. 12, in some of the embodiments of type B, a core 116 made of a ferrite material may be disposed in the central portion of the first induction coil 111 and side end portions of the second induction coil 114 and the third induction coil 113. In particular, the core 116 may be disposed in the respective side end portion of the second induction coil 114 and the third induction coil 113, and disposed on the same plane as that on which the second induction coil 114 and the third induction coil 113 are disposed, along at least a portion of the respective outer circumferences of the second induction coil 114 and the third induction coil 113.

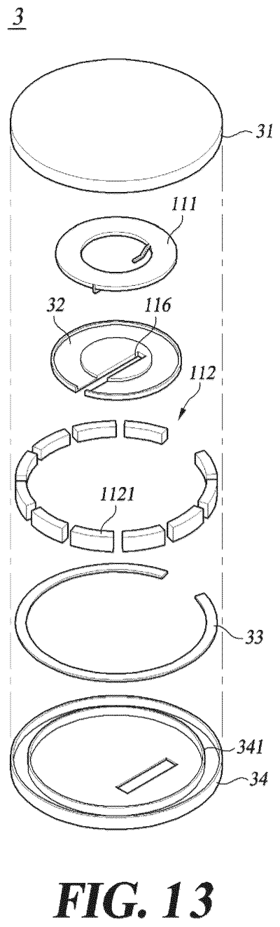

FIG. 13 is an exploded perspective view schematically illustrating a coil assembly according to an embodiment.

Referring to FIG. 13, in some embodiments, the first induction coil 111 and the magnetic assembly 112 may be provided as one coil assembly 3.

The coil assembly 3 is configured to accommodate the first induction coil 111 and the magnetic assembly 112 in the internal space formed by an upper housing 31 and a lower housing 34.

A partition wall 341 may be formed in the lower housing 34 so that the magnetic assembly 112 and the first induction coil 111 are disposed separately in the internal space, and the partition wall 341 may also be formed in the upper housing 31 rather than the lower housing 34.

A core structure 32 for providing the core 116 disposed in the central portion of the first induction coil 111 may also be provided in the internal space. The core structure 32 not only provides the core 116, but also provides a shape for seating of the first induction coil 111.

Meanwhile, the wireless power transmitting apparatus 1 may further include a permeable shield 33 (having the same configuration as a fixing frame) attached to the lower surface of the magnetic assembly 112 and made of the material with specific transmittance of 1, and the permeable shield 33 may be disposed in the internal space formed by the upper housing 31 and the lower housing 34. Specifically, the MPP requires the use of the permeable shield disposed on the lower surface of the magnetic assembly 112, and when the permeable shield 33 made of the material with a relative permeability of 1 is provided, there is an effect of greatly increasing the K value between the second and third induction coils 113 and 114 and the secondary coil.

TABLE 6

| dz | Tx_C | K Increase Rate (%) | Tx_R | K Increase Rate (%) |
|---|---|---|---|---|
| 0.5 | 0.9085 | −0.1 | 0.4092 | 1.3 |
| 1.0 | 0.8861 | 0.2 | 0.3963 | 0.9 |
| 1.5 | 0.8609 | 0.5 | 0.3833 | 0.9 |
| 2.0 | 0.8335 | 0.8 | 0.3697 | 0.8 |
| 2.5 | 0.8047 | 0.8 | 0.3565 | 0.6 |
| 3.0 | 0.7752 | 1.0 | 0.3438 | 0.8 |
| 3.5 | 0.7459 | 1.1 | 0.3311 | 0.9 |
| 4.0 | 0.7155 | 1.3 | 0.3178 | 0.4 |
| 4.5 | 0.6862 | 1.4 | 0.3063 | 0.6 |
| 5.0 | 0.6569 | 1.4 | 0.3940 | 0.3 |
| 5.5 | 0.6275 | 1.3 | 0.2825 | 0.4 |
| 6.0 | 0.6006 | 1.5 | 0.2709 | 0.5 |

Table 6 shows the coupling coefficient and an increase rate thereof in the embodiment illustrated in FIG. 12. Specifically, the measurement data in Table 6 was acquired by measuring the K values of the first and third induction coils 113 while moving the secondary coil which is the receiving coil of the power receiving unit 210 in the direction (dz direction) 5 perpendicular to the plane formed by the coil in a state where the secondary coil is aligned with the first induction coil 111. Here, Tx_C denotes the first induction coil 111, Tx_R denotes the third induction coil 113, and each K increase rate in the table indicates a K increase rate related to the induction coil in a left cell.

It can be seen from Table 6 that the K value was measured to be increased by about 0.1 to 1.5% in the embodiment illustrated in FIG. 12 compared to the embodiment in which the core 116 and the permeable shield 33 are not disposed.

TABLE 7

| dz | Tx_C | K Increase Rate (%) | Tx_R | K Increase Rate (%) |
|---|---|---|---|---|
| 0.5 | 0.9077 | −0.2 | 0.6876 | 70.2 |
| 1.0 | 0.8863 | 0.3 | 0.6687 | 70.3 |
| 1.5 | 0.8599 | 0.4 | 0.6491 | 70.9 |
| 2.0 | 0.8326 | 0.7 | 0.6291 | 71.6 |
| 2.5 | 0.8042 | 0.7 | 0.6088 | 71.8 |
| 3.0 | 0.7747 | 0.9 | 0.5888 | 72.6 |
| 3.5 | 0.7453 | 1.1 | 0.5688 | 73.4 |
| 4.0 | 0.7154 | 1.3 | 0.5487 | 73.4 |
| 4.5 | 0.6861 | 1.3 | 0.5291 | 73.8 |
| 5.0 | 0.6565 | 1.3 | 0.5088 | 73.7 |
| 5.5 | 0.6285 | 1.4 | 0.4905 | 74.2 |
| 6.0 | 0.6004 | 1.5 | 0.4716 | 74.9 |

Table 7 shows the coupling coefficient and an increase rate thereof in the embodiment illustrated in FIG. 12, like Table 6. Specifically, the measurement data in Table 7 was acquired by measuring the K values of the first and third induction coils 113 while moving the secondary coil which is the receiving coil of the power receiving unit 210 in the direction (dz direction) perpendicular to the plane formed by the coil in a state where the secondary coil is aligned with the third induction coil 113. Here, Tx_C denotes the first induction coil 111, Tx_R denotes the third induction coil 113, and each K increase rate in the table indicates a K increase rate related to the induction coil in a left cell.

Referring to Table 7, in the case of the first induction coil 111, there is no significant difference from the results in Table 6. However, in the case of the third induction coil 113, it can be seen that the K value was measured to be greatly increased by about 71% in the embodiment illustrated in FIG. 12 compared to the embodiment in which the core 116 and the permeable shield 33 are not disposed.

Meanwhile, the primary coil which is the coil of the power conversion unit 110, and the secondary coil which is the coil of the power receiving unit 210 transmit energy using an electromagnetic induction principle, as described above. Accordingly, when a foreign object exists between the primary coil and the secondary coil, the foreign object may cause concentration or distortion of the magnetic field formed by the primary coil, have an influence on the inductance of the primary coil and/or the secondary coil, and cause a current to be induced by the primary coil, resulting in a heat loss. As a result, the foreign object may reduce the power transmission efficiency between the primary coil and the second coil. In particular, when the foreign object is the material that forms a magnetic field, the foreign object may further reduce the power transmission efficiency between the first coil and the second coil compared to the material that does not form a magnetic field.

In the embodiment of type B, the magnetic elements 1121 are disposed above the second induction coil 114 and the third induction coil 113 (in a space with respect to the power receiving unit 210), and thus, the transfer loss (electromagnetic interference loss) of the second induction coil 114 and the third induction coil 113 may occur. In particular, the magnetic elements 1121 may be provided as the magnets with a strong magnetic force (for example, neodymium magnets; NdFeB), and in this case, the high transfer loss between the second induction coil 114 and the third induction coil 113 is likely to be caused.

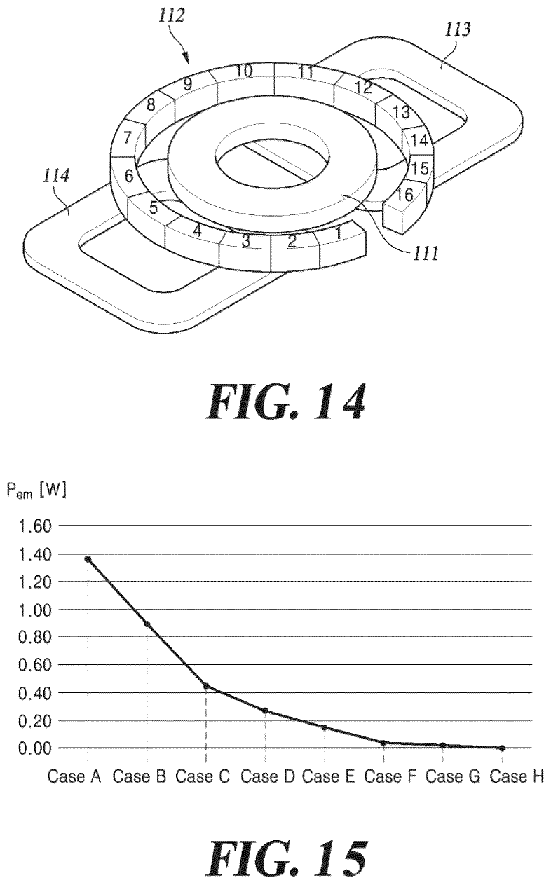

FIG. 14 is a diagram schematically illustrating numbered magnetic elements or magnetic units and induction coils.

In some embodiments, the magnetic elements 1121 or magnetic units 1122 may be disposed along the outer circumference of the first induction coil 111 outside the first induction coil 111, as illustrated in FIG. 14. Here, a predetermined number of magnetic elements 1121 are uniformly aligned to form one magnetic unit 1122, and since one magnetic unit 1122 physically behaves like one large magnetic element 1121, one numbered magnetic element illustrated in FIG. 14 may be the magnetic element 1121 or the magnetic unit 1122. In such embodiments, a plurality of magnetic elements 1121 or magnetic units 1122 may be disposed along the outer circumference of the first induction coil 111 outside the first induction coil 111, and in FIG. 14, 16 magnetic elements 1121 are disposed as an example.

Referring to FIG. 14, each magnetic element 1121 may cause the transfer loss of the second induction coil 114 and the third induction coil 113, and a higher transfer loss may be caused in order of magnetic elements numbered 12, 14, 13, 11, 10, and 15 (and magnetic elements with 5, 3, 4, 6, 7, and 2 symmetrical thereto).

When the transfer loss of each magnetic element 1121 is reviewed, it can be seen that a higher transfer loss is caused as the magnetic element 1121 is disposed to be closer to the central portion of a coil. Since the disposition of the magnetic elements 1121 in FIG. 14 is an example, such a conclusion can be understood as there being a space that causes a high transfer loss. For example, a transfer loss amount to be caused is different depending on a position in which a specific magnetic object is disposed between the primary coil and the secondary coil, and a higher transfer loss may be caused as the object is disposed in the central portion of the coil (a closed area formed by the coil; the same applies hereinafter) that is a space in which a wire constituting the coil is not disposed. Typically, the magnetic elements numbered 12, No. 13, and No. 14 disposed in the closed area formed by the third induction coil 113 may cause a high transfer loss, and especially the magnetic elements numbered 12 and No. 14 relatively closer to the coil wire than the magnetic element numbered 13 that is present at the center of the closed area may cause the highest transfer loss.

FIG. 15 illustrates the graph showing a transfer loss amount according to a combination of the magnetic elements or the magnetic units numbered according to FIG. 14, and shows the power loss amount measured or calculated while removing some of the magnetic elements constituting the magnetic assembly.

In FIG. 15, a horizontal axis indicates an increase in the number of magnetic elements to be removed with movement to the right in a manner in which magnetic elements having a large influence on a transfer loss amount (Pem) are removed first, and magnetic elements having a next significant influence are sequentially removed. Specifically, the magnetic elements disposed in the closed area formed by the third induction coil 113 are removed in order of 12 →14→13, magnetic elements close to the closed area are then removed in order of 11→15, and the transfer loss amount is measured.

Meanwhile, in FIG. 15, Case A indicates a state where all the magnetic elements numbered 1 to 16 are disposed, Case B is a state where the magnetic element numbered 12 and its symmetrical magnetic element numbered 5 have been removed from Case A, Case C is a state where the magnetic element numbered 14 and its symmetrical magnetic element numbered 3 have been further removed from Case B, Case D is a state where the magnetic element numbered 13 and its symmetrical magnetic element numbered 4 have been further removed from Case C, Case E is a state where the magnetic element numbered 11 and its symmetrical magnetic element numbered 6 have been further removed from Case D, Case F is a state where the magnetic element numbered 10 and its symmetrical magnetic element numbered 7 have been further removed from Case E, Case G is a state where the magnetic element numbered 15 and its symmetrical magnetic element numbered 2 have been further removed from Case F, and Case H is a state where the magnetic element numbered 9 or 16 and its symmetrical magnetic element numbered 8 or 1 have been further removed from Case G.

It can be seen from FIG. 15 that Pem decreases from Case A to Case H and, in a curve obtained by non-linearly connecting Pem for the respective cases (in the form of an exponential function in FIG. 15), a differential value in each case decreases as Case moves to Case H. In other words, a decrease amount in Pem is large in an initial stage where the magnetic elements 1121 are removed from Case A (a state where a small number of magnetic elements 1121 have been removed), but the decrease amount in Pem becomes smaller in a later stage (a state where a large number of magnetic elements 1121 have been removed).

Referring to FIGS. 14 and 15, in some embodiments, a structure for minimizing the transfer loss caused by the magnetic elements 1121 disposed above the second induction coil 114 and the third induction coil 113 can be proposed. Specifically, in such embodiments, among the plurality of magnetic elements 1121, the adjacent magnetic elements 1121 may be disposed to form at least one gap spaced apart from a central portion (a second central portion) of the second induction coil 114 and a central portion (a third central portion) of the third induction coil 113.

In some embodiments in which the gap is formed, the plurality of magnetic elements 1121 may include a first magnetic element (for example, the magnetic element numbered 11 or No. 6), a second magnetic element (for example, the magnetic element numbered 13 or No. 4) adjacent to the first magnetic element, and a third magnetic element (for example, the magnetic elements numbered 15 or 2) adjacent to the second magnetic element. Here, the second magnetic element may be disposed inside the second central portion or the third central portion, and the first and third magnetic elements may be disposed outside the second central portion and the third central portion. Accordingly, the first to third magnetic elements may be disposed to be spaced apart from each other and form two gaps around the second magnetic element.

At least one gap may be created by removing the numbered magnetic elements (some of the magnetic elements numbered 1 to 16) illustrated in FIG. 14. That is, at least one gap is formed from Case A, so that Case B to Case H states can be reached.

Considering the graph of FIG. 15, in such embodiments, at least one gap is preferably provided in a state such as Case B to Case D, but the present disclosure is not limited thereto.

Meanwhile, when the magnetic elements 1121 are removed, the magnetic force between the wireless power transmitting apparatus 1 and the electronic device 2 may be reduced and the alignment holding power between the primary coil and the secondary coil may decrease. However, in the case of, for example, Cases B to D, since the reduction in transfer loss is large, the formation of such gaps can provide the effect of increasing the transmission efficiency of the wireless power transmitting apparatus 1 with triple coils including the magnetic assembly 112. That is, in this embodiment, the at least one gap provides the effect of minimizing transfer loss and increasing transmission efficiency of the wireless power transmitting apparatus 1. Further, the decrease in the alignment holding power caused by the removal of the magnetic elements 1121 can be compensated for through the disposition of the magnetic elements according to the Halbach array.

In some embodiments, a non-conductor may be disposed in at least one gap. The non-conductor may be provided as a material such as FR4, for example. The non-conducting material may be fixed to the top surface of the fixing frame 33 (having the same configuration as the permeable shield) like the magnetic elements 1121.

The fixing frame 33 may be made of a non-conductive material as described above.

When the magnetic elements 1121 are disposed with at least one gap, fixation may be very difficult due to the magnetic force formed therebetween, and the non-conductor may physically serve to fix such a disposition or array. Further, since the non-conductor does not cause a high transfer loss between the primary coil and the secondary coil, the non-conductor serves as at least one gap (a state where nothing is disposed, and relative permeability is 1), thereby providing the effect of reducing the transfer loss caused by the disposition of the magnetic elements 1121.

The wireless power transmitting apparatus described in the present disclosure can be described as follows.

A wireless power transmitting apparatus according to an embodiment may include a first induction coil; an inverter configured to convert a direct current into an alternating current and provide the alternating current to the first induction coil; and a magnetic assembly including a plurality of magnetic elements disposed in the Halbach array outside the first induction coil.

In one embodiment, the wireless power transmitting apparatus may further include a second induction coil and a third induction coil having an axis in the same direction as that of an axis of the first induction coil and disposed to be symmetrical to each other about the axis of the first induction coil.

In one embodiment, the second induction coil and the third induction coil may be disposed on a same plane, and the first induction coil may be disposed above the plane.

In one embodiment, the second induction coil and the third induction coil may be disposed on a same plane, and the first induction coil may be disposed below the plane.

In one embodiment, a resonance circuit including the first induction coil and a capacitor connected in series to the first induction coil may be configured so that an effective capacitance is 500 nF when an operating frequency of the inverter is 127 kHz, and 15 nF or 20 nF when the operating frequency of the inverter is 360 kHz.

In one embodiment, the capacitor may include a first capacitor, a second capacitor, and

a third capacitor coupled in parallel with each other, and a first switch and a second switch may be coupled in series to the second capacitor and the third capacitor, respectively.

In one embodiment, the first capacitor may have a capacitance of 15 nF, the second capacitor may have a capacitance of 5 nF, and the third capacitor may have a capacitance of 480 nF.

In one embodiment, the first switch and the second switch may be configured to be turned on when the operating frequency of the inverter is 127 kHz.

In one embodiment, the first switch may be configured to be turned on and the second switch may be configured to be turned off when the operating frequency of the inverter is 360 kHz.

In one embodiment, the first switch and the second switch may be configured to be turned off when the operating frequency of the inverter is 360 kHz.

In one embodiment, a predetermined number of magnetic elements may be disposed in the Halbach array to constitute one magnetic unit, and the magnetic assembly may include a plurality of the magnetic units disposed along the outer circumference of the first induction coil.

In one embodiment, in the magnetic unit, the predetermined number of magnetic elements may be arranged along at least the portion of the outer circumference of the first induction coil to form at least a partial section of the outer circumference of the first induction coil.

In one embodiment, the predetermined number of magnetic elements constituting the magnetic unit may be arranged along the axis formed in the radial direction of the first induction coil from the outer side of the first induction coil, and a plurality of the magnetic units may be disposed along the outer circumference of the first induction coil.

A wireless power transmitting apparatus according to another embodiment may include a first induction coil; a second and third induction coils having axes in the same direction as the axis of the first induction coil and disposed to be symmetrical to each other about the axis of the first induction coil; and a magnetic assembly including a plurality of magnetic elements disposed outside the first induction coil, the second induction coil and the third induction coil may be disposed on a same plane, the first induction coil and the magnetic assembly may be disposed below the plane, and a core made of ferrite material may be disposed in a central portion of the first induction coil and at least a portion below the second induction coil and the third induction coil.

In one embodiment, the core may be disposed at one end portion of the second induction coil and the other end portion of the third induction coil below the second induction coil and the third induction coil.

A wireless power transmitting apparatus according to another embodiment may include a first induction coil, a second induction coil and a third induction coil having axes in the same direction as that of an axis of the first induction coil and disposed to be symmetrical to each other about the axis of the first induction coil, and a magnetic assembly including a plurality of magnetic elements disposed outside the first induction coil, the second induction coil and the third induction coil may be disposed on a same plane, the first induction coil and the magnetic assembly may be disposed above the plane, and a core made of ferrite material may be disposed in a central portion of the first induction coil and respective side end portions of the second induction coil and the third induction coil.

In one embodiment, the core disposed in the respective side end portions of the second induction coil and the third induction coil may be disposed on the same plane as the plane along at least a portion of the outer circumference of each of the second induction coil and the third induction coil.

In one embodiment, the wireless power transmitting apparatus may further include a permeable shield attached to a lower surface of the magnetic assembly and made of a material with specific transmittance of 1.

A wireless power transmitting apparatus according to another embodiment may include a first induction coil, a second induction coil and a third induction coil having axes in the same direction as that of an axis of the first induction coil and disposed on one side and the other side with respect to the axis of the first induction coil, and a magnetic assembly including a plurality of magnetic elements disposed along an outer circumference of the first induction coil outside the first induction coil, and two adjacent magnetic elements among the plurality of magnetic elements may be disposed to be spaced apart from each other to form a gap in a second central portion of the second induction coil or a third central portion of the third induction coil. In one embodiment, the plurality of magnetic elements may include a first magnetic

element, a second magnetic element adjacent to the first magnetic element, and a third magnetic element adjacent to the second magnetic element, the second magnetic element may be disposed inside the second central portion or the third central portion, and the first and third magnetic elements may be disposed outside the second central portion and the third central portion.

In one embodiment, the second induction coil and the third induction coil may be disposed on a same plane, and the first induction coil may be disposed above the plane.

In one embodiment, a predetermined number of magnetic elements may constitute one magnetic unit, and the magnetic assembly may include a plurality of magnetic units disposed along the outer circumference of the first induction coil.

In one embodiment, a fixing frame attached to a lower surface of the magnetic assembly may be further included.

In one embodiment, the fixing frame may be constructed using a non-conductive material.

In one embodiment, a non-conductor may be disposed in the gap.

In one embodiment, the non-conductor may be FR4.

This specification is not limited to the described embodiments, and it will be apparent to those skilled in the art that various modifications and variations can be made without departing from the spirit and scope of the present invention. Accordingly, such modifications or variations should fall within the scope of the claims of the present invention.

1. An apparatus for transmitting power wirelessly, comprising:
a first induction coil;
an inverter configured to convert a direct current into an alternating current and provide the alternating current to the first induction coil; and
a magnetic assembly including a plurality of magnetic elements disposed in a Halbach array outside the first induction coil.

2. The apparatus of claim 1, further comprising:
a second induction coil and a third induction coil having an axis in the same direction as that of an axis of the first induction coil and disposed to be symmetrical to each other about the axis of the first induction coil.

3. The apparatus of claim 2, wherein the second induction coil and the third induction coil are disposed on a same plane, and the first induction coil is disposed above the plane.

4. The apparatus of claim 2, wherein the second induction coil and the third induction coil are disposed on same plane, and the first induction coil is disposed below the plane.

5. The apparatus of claim 1, wherein a resonance circuit including the first induction coil and a capacitor connected in series to the first induction coil is configured so that an effective capacitance is 500 nF when an operating frequency of the inverter is 127 kHz, and 15 nF or 20 nF when the operating frequency of the inverter is 360 KHz.

6. The apparatus of claim 5, wherein the capacitor includes a first capacitor, a second capacitor, and a third capacitor coupled in parallel with each other, and a first switch and a second switch are coupled in series to the second capacitor and the third capacitor, respectively.

7. The apparatus of claim 6, wherein the first capacitor has a capacitance of 15 nF, the second capacitor has a capacitance of 5 nF, and the third capacitor has a capacitance of 480 nF.

8. The apparatus of claim 7, wherein the first switch and the second switch are configured to be turned on when the operating frequency of the inverter is 127 kHz.

9. The apparatus of claim 7, wherein the first switch is configured to be turned on and the second switch is configured to be turned off when the operating frequency of the inverter is 360 KHz.

10. The apparatus of claim 7, wherein the first switch and the second switch are configured to be turned off when the operating frequency of the inverter is 360 kHz.

11. The apparatus of claim 1, wherein a predetermined number of magnetic elements are disposed in the Halbach array to constitute one magnetic unit, and the magnetic assembly includes a plurality of the magnetic units disposed along an outer circumference of the first induction coil.

12. The apparatus of claim 11, wherein in the magnetic unit, the predetermined number of magnetic elements are arranged along at least a portion of the outer circumference of the first induction coil to form at least a partial section of the outer circumference of the first induction coil.

13. The apparatus of claim 11, wherein the predetermined number of magnetic elements constituting the magnetic unit are arranged along an axis formed in a radial direction of the first induction coil from the outer side of the first induction coil, and a plurality of the magnetic units are disposed along the outer circumference of the first induction coil.
